(19) United States
(12) Patent Application Publication
(10) Pub. No.: US 2005/0237407 A1
(43) Pub. Date: Oct. 27, 2005

(54) CMOS image sensor for processing analog signal at high speed

(76) Inventor: Chang-Min Bae, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/097,851

(22) Filed: Mar. 30, 2005

(30) Foreign Application Priority Data
Apr. 26, 2004 (KR) 2004-28746
Dec. 30, 2004 (KR) 2004-116853

(51) Int. Cl. H04N 5/217

(52) U.S. Cl. 348/308

(57) ABSTRACT

A CMOS image sensor includes: a pixel array having a plurality of first pixels, a plurality of second pixels and a plurality of third pixels that are arranged in matrix form and respectively correspond to a first color, a second color and a third color. A first analog signal processing path is arranged in one side of the pixel array to process analog signals outputted from the first pixels, and a second analog signal processing path is arranged in the other side of the pixel array to process analog signals outputted from the second pixels or the third pixels. The first analog signal processing path includes a lower CDS part where one CDS circuit per two adjacent columns of the pixel array is provided. The second analog signal processing path includes an upper CDS part where one CDS circuit per two adjacent columns of the pixel array is provided.

1. Field of the Invention

The present invention relates to a CMOS image sensor; and, more particularly, to a CMOS image sensor for processing an analog signal at high speed and a signal processing method therein.

2. Description of Related Art

An image sensor is an apparatus to convert an optical image into an electrical signal. Such an image sensor is largely classified into a complementary metal oxide semiconductor (CMOS) image sensor and a charge coupled device (CCD).

In the case of the CCD, individual MOS capacitors are disposed very close to one another and charge carriers are stored in and transferred to the capacitors. Meanwhile, in the case of the CMOS image sensor, a pixel array is constructed using a CMOS integrated circuit technology and output data are detected in sequence through a switching operation. Since the CMOS image sensor has an advantage of low power consumption, it is widely used in a personal communication system, such as a hand-held phone.

FIG. 1 is a diagram of a conventional CMOS image sensor. In FIG. 1, a processing of image data (analog signals) from pixels is shown.

Referring to FIG. 1, the conventional CMOS image sensor includes a pixel array 11 where red (R), green (G) and blue (B) pixels are arranged in an M N matrix form. A correlated double sampling (CDS) part 12 including CDS circuits is provided at a lower side of the pixel array 11. The CDS circuit is provided at each column. An analog signal processor (ASP) 13 is provided at a right side of the pixel array 11 and processes the analog signals outputted from the CDS part 12.

The CDS circuit samples a reset signal and a data signal from each pixel and applies the sampled signals on an analog data bus. Then, the ASP 13 calculates a difference value between the reset signal and the data signal and amplifies it. Accordingly, a pure pixel data of an actual object can be obtained.

In reading a pixel data, the pixels arranged along one row of the pixel array 11 are transferred to the respective CDS circuits of the CDS part 12 at once and at the same time (at the same clock). Under the control of a column driver 14, the outputs of the CDS circuits are sequentially transferred to the ASP 13 and then processed therein.

As described above, according to the conventional CMOS image sensor, when one row is selected, the pixel signals (reset signal and data signal) of the selected row are stored in the corresponding CDS circuit. Then, the signals of the respective CDS circuits are sequentially transferred to the ASP by the column driver.

Meanwhile, if millions of pixels are arranged, the number of pixels arranged in a row direction increases and therefore the number of the CDS circuits must increase as much. Also, the analog data bus is commonly connected to a large number of CDS circuits. Thus, a load capacitance of the analog data bus also increases.

For these reasons, the conventional system cannot achieve high-speed operation. In order for the high-speed operation, the functional block (especially, ASP) needs to be improved to obtain a desired signal processing performance. Also, if a high-speed system is designed, a timing margin for stabilizing a signal value within a settling time is small. Therefore, the reliability and productivity of the devices are degraded.

Further, as shown in FIG. 1, the conventional CMOS image sensor includes one CDS circuit at each column. Transistors for the CDS circuits must be laid out within a pixel pitch, which corresponds to an area of one pixel. However, in the case of the image sensor having millions of pixels, a pixel size is very small. Therefore, the layout of the CDS circuits within the pixel pitch is difficult.

### SUMMARY OF THE INVENTION

It is, therefore, an object of the present invention to provide a CMOS image sensor, in which the signals are processed through multi-paths, but color signals (that is, R, G and B signals) are processed through the path of the same ASP. In this manner, the offset problem can be minimized and one CDS circuit per two pixel pitches can be laid out. Therefore, the layout margin of the CDS circuit can increase and the number of the CDS circuits decreases.

In an aspect of the present invention, there is provided a CMOS image sensor, including: a pixel array having a plurality of first pixels, a plurality of second pixels and a plurality of third pixels that are arranged in matrix form and respectively correspond to a first color, a second color and a third color; a first analog signal processing path arranged in one side of the pixel array to process analog signals outputted from the first pixels of the pixel array; and a second analog signal processing path arranged in the other side of the pixel array to process analog signals outputted from the second pixels or the third pixels of the pixel array, wherein the first analog signal processing path includes a lower CDS part where one CDS circuit per two adjacent columns of the pixel array is provided, the lower CDS part being configured to receive output signals of the first pixels corresponding to one of the two columns, and the second analog signal processing path includes an upper CDS part where one CDS circuit per two adjacent columns of the pixel array is provided, the upper CDS part being configured to receive output signals of the second pixels or the third pixels corresponding to one of the two columns.

The first analog signal processing path further includes a first selecting means for transferring a signal outputted from one pixel of two pixels to the CDS circuit of the lower CDS part, the two pixels existing on the same row and corresponding to two adjacent columns, and the second analog signal processing path further includes a second selecting means for transferring a signal outputted from the other pixel to the CDS circuit of the upper CDS part.

The first analog signal processing path further includes at least one lower analog data bus on which output signals of the CDS circuits of the lower CDS part are loaded, and a lower ASP connected to the lower analog data bus. The second analog signal processing path further includes at least one upper analog data bus on which output signals of the CDS circuits of the upper CDS part are loaded, and an upper ASP connected to the upper analog data bus.

The first analog signal processing path further includes a first column driver configured to generate a select signal for transferring the output signals of the CDS circuits of the lower CDS part to the lower analog data bus in response to a column address. The second analog signal processing path further includes a second column driver configured to generate a select signal for transferring the output signals of the CDS circuits of the upper CDS part to the lower analog data bus in response to a column address.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram of a conventional CMOS image sensor, showing an analog signal processing path;

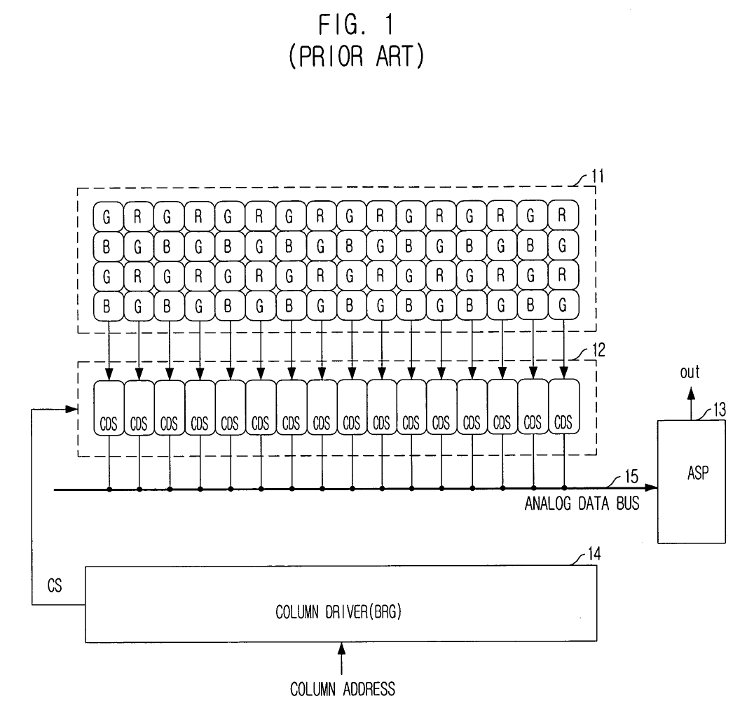

FIG. 2 is a diagram of a CMOS image sensor in accordance with a first embodiment of the present invention, showing an analog signal processing path; and

FIG. 3 is a diagram of a CMOS image sensor in accordance with a second embodiment of the present invention, showing an analog signal processing path.

### DETAILED DESCRIPTION OF THE INVENTION

Hereinafter, the present invention will be described in detail with reference to the accompanying drawings.

### First Embodiment

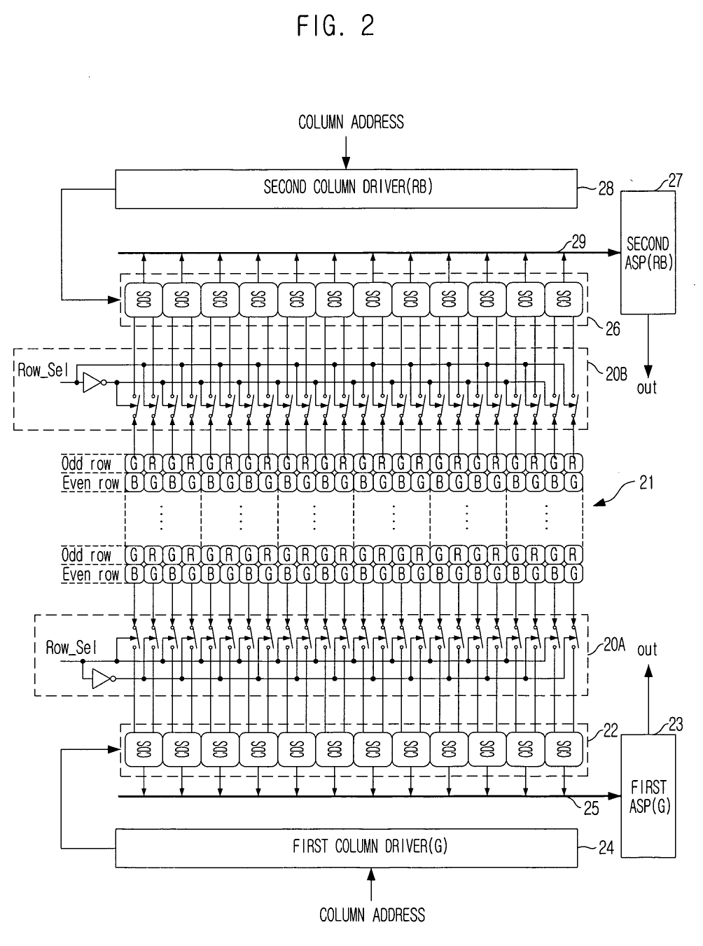

FIG. 2 is a diagram of a CMOS image sensor in accordance with a first embodiment of the present invention. A path for sampling signals from pixels in a CDS circuit is divided into two. At each path, two pixels share one CDS circuit and one CDS circuit per two pixel pitches are laid out.

Referring to FIG. 2, the CMOS image sensor includes a pixel array 21 where red (R), green (G) and blue (B) pixels are arranged in an M N matrix form. CDS parts 22 and 26 including CDS circuits are respectively provided at lower and upper sides of the pixel array 21. In each of the CDS parts 22 and 26, one CDS circuit per two pixels of two adjacent columns is provided. A first ASP 23 is provided at a right side of the pixel array 21 to process the analog signals outputted from the lower CDS part 22, and a second ASP 27 is provided at a right side of the pixel array 21 to process the analog signals outputted from the upper CDS part 26.

The pixel array 21 includes a plurality of even rows and a plurality of odd rows. In the odd row, a G pixel is arranged in a first column, and a G pixel and an R pixel are alternately arranged. In the even row, a B pixel is arranged in a first column, and a B pixel and a G pixel are alternately arranged.

The CDS circuits arranged in the upper and lower sides share two pixels that exist in the same row and correspond to two adjacent columns. If a pixel signal from one pixel of the two adjacent pixels is transferred to the lower CDS circuit, a pixel signal from the other pixel must be outputted to the upper CDS circuit. For this, the output signals of the pixel array are transferred through selecting parts 20a and 20b to the CDS part.

In this embodiment, the selecting parts 20a and 20b are configured with switches that are driven in response to a row select signal row_sel. The row select signal row_sel is a logic “0” when the even row is selected. On the contrary, if the row select signal row_sel is a logic “1” when the odd row is selected. Accordingly, signals of the G pixels in the pixel array are all transferred the lower CDS circuits, and signals of the B or R pixels are all transferred to the upper CDS circuits.

The selecting parts 20a and 20b can be configured in various manners. For example, a plurality of control signals can be used and a multiplexer can be used instead of the switches.

The output signals of the lower CDS part 22 are transferred through a first analog data bus 25 to the first ASP 23, and the output signals of the upper CDS part 26 are transferred through a second analog data bus 29 to the second ASP 27.

The outputs of the CDS circuits of the lower CDS part 22 are applied on the first analog data bus 25 in response to the select signal CS that is generated from the first column driver 24, and the outputs of the CDS circuits of the upper CDS part 26 are applied on the select signal CS that is generated from the second column driver 28.

An entire operation of reading pixel data will be described below. If one row of the pixel array 21 is selected, the output signals of the G pixels of the selected row are transferred to the CDS circuits of the lower CDS part 22 at once, and the output signals of the B or R pixels of the selected row are transferred to the CDS circuits of the upper CDS part 26.

Then, the first column driver 24 drives the CDS circuits of the lower CDS part 22 in sequence, so that the output signals are loaded on the first analog data bus 25. These signals are processed by the first ASP 23. In addition, the second column driver 28 drives the CDS circuits of the upper CDS part 26 in sequence, so that the output signals are loaded on the second analog data bus 29. These signals are processed by the second ASP 27.

In this embodiment, since the signals of the R and B pixels and the signals of the G pixels are processed through different paths, two signals can be processed at one clock at the same time. Therefore, an analog system having two times bandwidth can be implemented.

Also, since two ASPs are provided, their role is reduced by half. Therefore, the ASP can use a low-speed system whose time margin is sufficient.

In addition, while the signals are processed through multi-paths, the color signals (that is, R, G and B signals) are processed through the path of the same ASP. In this manner, the offset problem can be minimized and one CDS circuit per two pixel pitches can be laid out. Therefore, the layout margin of the CDS circuit can increase and the number of the CDS circuits decreases, so that the power consumption is reduced.

### Second Embodiment

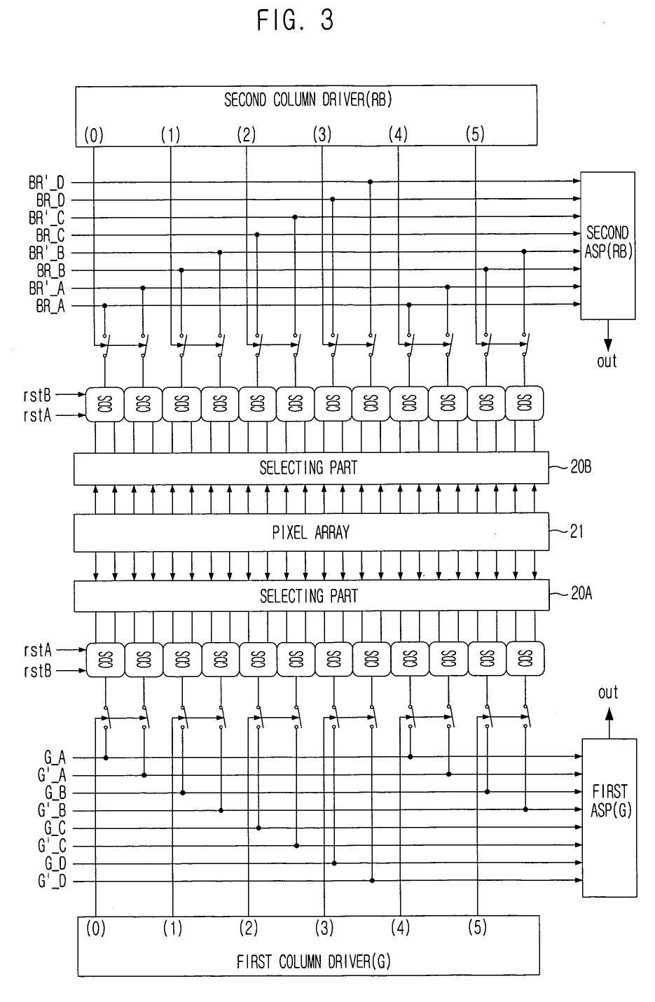

FIG. 3 is a diagram of a CMOS image sensor in accordance with a second embodiment of the present invention. In this embodiment, eight analog data buses are respectively applied to the upper and lower paths. Structures of a pixel array 21 and selecting parts 20a and 20b are same to those of the first embodiment.

The load capacitance of the analog data line of each path is decreased much more, thereby reducing the design burden of the ASP and improving the signal processing speed.

According to the present invention, the analog signal is processed through the multi-paths, so that the signal processing speed is improved through the stable signal processing system. Also, while the signals are processed through the multi-paths, the signals of the same pixels of the pixel array are processed through the same path. In this manner, the offset between the same pixels can be minimized and thus the picture quality can be improved. In addition, since one CDS circuit per two pixel pitches is laid out, the layout problem of the CDS circuit due to the small pixel pitch can be solved.

Further, a mismatch between the transistors can also be minimized. Therefore, a fixed pattern noise (FPN) can be suppressed to the maximum. Since a small number of CDS circuits are used, the power consumption is reduced.

The present application contains subject matter related to Korean patent applications No. 2004-28746 and No. 2004-116853, filed in the Korean Patent Office on Apr. 26, 2004 and Dec. 30, 2004 respectively, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

1. A CMOS image sensor, comprising:
a pixel array having a plurality of first pixels, a plurality of second pixels and a plurality of third pixels that are arranged in matrix form and respectively correspond to a first color, a second color and a third color;
a first analog signal processing path arranged in one side of the pixel array to process analog signals outputted from the first pixels of the pixel array; and
a second analog signal processing path arranged in the other side of the pixel array to process analog signals outputted from the second pixels or the third pixels of the pixel array,
wherein the first analog signal processing path includes a lower CDS part where one CDS circuit per two adjacent columns of the pixel array is provided, the lower CDS part being configured to receive output signals of the first pixels corresponding to one of the two columns, and the second analog signal processing path includes an upper CDS part where one CDS circuit per two adjacent columns of the pixel array is provided, the upper CDS part being configured to receive output signals of the second pixels or the third pixels corresponding to one of the two columns.

2. The CMOS image sensor as recited in claim 1, wherein the first analog signal processing path further includes a first selecting means for transferring a signal outputted from one pixel of two pixels to the CDS circuit of the lower CDS part, the two pixels existing on the same row and corresponding to two adjacent columns, and the second analog signal processing path further includes a second selecting means for transferring a signal outputted from the other pixel to the CDS circuit of the upper CDS part.

3. The CMOS image sensor as recited in claim 2, wherein the first analog signal processing path further includes:
at least one lower analog data bus on which output signals of the CDS circuits of the lower CDS part are loaded; and
a lower ASP connected to the lower analog data bus.

4. The CMOS image sensor as recited in claim 3, wherein the second analog signal processing path further includes:
at least one upper analog data bus on which output signals of the CDS circuits of the upper CDS part are loaded; and
an upper ASP connected to the upper analog data bus.

5. The CMOS image sensor as recited in claim 3, wherein the first analog signal processing path further includes a first column driver configured to generate a select signal for transferring the output signals of the CDS circuits of the lower CDS part to the lower analog data bus in response to a column address.

6. The CMOS image sensor as recited in claim 4, wherein the second analog signal processing path further includes a second column driver configured to generate a select signal for transferring the output signals of the CDS circuits of the upper CDS part to the lower analog data bus in response to a column address.

7. The CMOS image sensor as recited in claim 2, wherein the pixel array includes:
a plurality of even rows where the first pixel is arrange at a first column and the first pixel and the second pixel are alternately arranged; and
a plurality of odd rows where the third pixel is arranged at a first column and the third pixel and the first pixel are alternately arranged.

8. The CMOS image sensor as recited in claim 7, wherein the first switching means and the second selecting means are configured with switching elements that are controlled by a row select signal having information on the odd or even row.

9. The CMOS image sensor as recited in claim 8, wherein the first pixel, the second pixel and the third pixel are a G pixel, an R pixel and a B pixel, respectively.
